(19) United States
(12) Patent Application Publication
(10) Pub. No.: US 2025/0091238 A1
(43) Pub. Date: Mar. 20, 2025

(54) cutting tool

(71) Applicant: Joseph Magiera, Ironwood, MI (US)

(72) Inventor: Joseph Magiera, Ironwood, MI (US)

(21) Appl. No.: 18/405,955

(22) Filed: Jan. 5, 2024

Related U.S. Application Data
(60) Provisional application No. 63/539,098, filed on Sep. 19, 2023.

(51) Int. Cl. B26B 23/00; B25G 1/08; B27B 21/04

(52) U.S. Cl. CPC B26B 23/00; B25G 1/08; B27B 21/04

(57) ABSTRACT

A cutting tool is disclosed for permitting a user to selectively chop and saw fibrous material. The cutting tool includes an elongate body having a first end and a second end disposed spaced from the first end. The elongate body defines a handle which is held by the user to hold the cutting tool during use thereof. The elongate body defines a slot and a channel cooperating with the slot. The slot and channel extend between the first end and the second end of the elongate body. A hatchet head is rigidly secured to the first end of the elongate body for selectively permitting chopping of the fibrous material during use of the cutting tool. A saw slidably cooperates with the channel such that in a stowed disposition of the saw, the saw is disposed within the slot and the channel. However, in an operative disposition of the saw, the saw is slidably moved relative to the channel away from the hatchet head for selectively permitting the user to saw the fibrous material.

### CROSS REFERENCE TO RELATED APPLICATION

The present application is a Complete application pursuant to Provisional Patent application U.S. Ser. No. 63/539,098, filed Sep. 19, 2023 and entitled “A cutting tool”. All of the disclosure of U.S. Ser. No. 63/539,098 is incorporated herein by reference.

### BACKGROUND OF THE INVENTION

### Field of the Invention

The present invention relates to a cutting tool.

More specifically, the present invention relates to a cutting tool for permitting a user to selectively chop and saw fibrous material such as firewood and the like.

### Background Information

When camping, campers will often prepare a campfire as it is enjoyable to sit around a campfire during the evening. Additionally, the campfire tends to deter wild animals from coming too close to the campsite.

However, a campfire often necessitates chopping and sawing firewood to suitable lengths. Therefore, the camper will usually include a hatchet and a saw amongst the camping equipment.

The present invention provides a combined cutting tool which permits the user to both chop and to saw firewood. For example, a piece of firewood may include a fairly thick portion of wood with a relatively thin branch extending from the thick portion. A hatchet part of the combined hatchet and saw of the present invention can then be used for chopping the thin branch from the thicker portion. The saw of the present invention can then be used to saw the thin branch into suitable lengths for the campfire.

In the prior art, a combined hatchet and retractable saw tool has been proposed but the saw includes a pivot for the saw so that the saw is either in the stowed disposition or pivoted out to the fully extended sawing disposition. Accordingly, the pivoting prior art saw has required a relatively complex mechanism for locking the saw against any pivoting thereof during a sawing operation.

The present invention provides a saw which extends and retracts longitudinally relative to the hatchet head. Such longitudinal movement of the saw has at least the following advantages over the prior art pivoting saw. First, the saw of the present invention can be extended away from the hatchet head to any number of desired settings thus providing a variable length saw. Second, any simple wedge can be provided for locking the saw in a desired sawing disposition thereof. Third, unlike the pivoting saw arrangement, the present invention avoids any potentially hazardous contact between the user's fingers and the saw during movement of the saw to the extended disposition thereof.

Therefore, a primary feature of the present invention is the provision of a cutting tool which extends and retracts longitudinally relative to the hatchet head.

Another feature of the present invention is the provision of a cutting tool in which the saw can be extended away from the hatchet head to any number of desired settings thus providing a variable length saw.

Yet another feature of the present invention is the provision of a cutting tool in which any simple wedge can be provided for locking the saw in a desired sawing disposition thereof.

Yet another feature of the present invention is the provision of a cutting tool which avoids any potentially hazardous contact between the user's fingers and the teeth of the saw during movement of the saw to the extended disposition thereof.

Other features and advantages of the present invention will be readily apparent to those skilled in the art by a consideration of the detailed description of a preferred embodiment of the present invention contained herein.

### SUMMARY OF THE INVENTION

The present invention relates to a cutting tool for permitting a user to selectively chop and saw fibrous material such as brush and firewood. The cutting tool includes an elongate body having a first end and a second end disposed spaced from the first end. The elongate body defines a handle which is held by the user to hold the cutting tool during use thereof. The elongate body defines a slot and channel which extend between the first end and the second end of the elongate body. A hatchet head is rigidly secured to the first end of the elongate body for selectively permitting chopping of the fibrous material during use of the cutting tool.

A saw slidably cooperates with the channel such that in a stowed disposition of the saw, the saw is disposed within the slot and channel. However, in an operative disposition of the saw, the saw is slidably moved longitudinally relative to the channel away from the hatchet head for selectively permitting the user to saw the fibrous material.

In a more specific embodiment of the present invention, the fibrous material

is wood.

Moreover, the elongate body includes a longitudinal length which extends

from the first

end to the second end of the elongate body.

Also, the elongate body has a first face and a second face spaced relative to

the first face.

Additionally, the elongate body is fabricated from wood.

In another embodiment of the present invention, the elongate body is

fabricated from

metal.

In a further embodiment of the present invention, the elongate body is

fabricated from a

plastics material.

Additionally, the plastics material is molded.

Furthermore, in each of the embodiments of the present invention, the slot extends longitudinally along a portion of the length of the elongate body such that the slot extends between the hatchet head and the second end of the elongate body.

Also, the slot extends from the first face to the second face of the elongate

body.

The channel extends from the slot to the second end of the elongate body

for the

longitudinal reception therethrough of the saw.

Moreover, the elongate body defines a transverse opening which is disposed

adjacent to

the first end of the elongate body for the rigid reception therein of the hatchet head such that the hatchet head is securely fastened to and extends transversely through the transverse opening.

Also, the saw includes a proximal end and a distal end, the distal end being

spaced

relative to the proximal end.

The saw defines an internally threaded hole disposed adjacent to the

proximal end of the

saw.

Furthermore, a tensioning fastener threadably cooperates with the internally

threaded

hole, the tensioning fastener cooperating with the slot such that when the tensioning fastener is rotated relative to the threaded hole, the tensioning fastener is selectively urged into a locked disposition relative to the slot at any desired location from the stowed disposition to the operative disposition of the saw.

Additionally, the tensioning fastener includes a threaded stem which

threadably

cooperates with the internally threaded hole, the stem having a first and a second extremity. A thumbscrew is rigidly secured to the first extremity of the stem and the second end of the stem threadably cooperates with the internally threaded hole of the saw such that when the thumbscrew is rotated, the thumbscrew cooperates with the slot for locking the saw at a selected location anywhere from the stowed disposition of the saw to a fully longitudinally extended disposition of the saw.

### BRIEF DESCRIPTION OF THE DRAWINGS

FIG. 1 is a side elevational view of a cutting tool according to the present invention including a safety sheath;

FIG. 2 is a similar view to that shown in FIG. 1 but shows the safety sheath having been removed for use of the cutting tool when being used as a hatchet;

FIG. 3 is an enlarged sectional view taken on the line 3-3 of FIG. 2 and shows the saw in the stowed disposition thereof;

FIG. 4 is an enlarged view taken on the line 4-4 of FIG. 2 and shows the saw in the stowed disposition thereof;

FIG. 5 is a similar view to that shown in FIG. 2 but shows the saw in the operable disposition thereof; and

FIG. 6 is a view taken on the line 6-6 of FIG. 2.

Similar reference characters refer to similar parts throughout the various views of the drawings.

### DETAILED DESCRIPTION OF THE DRAWINGS

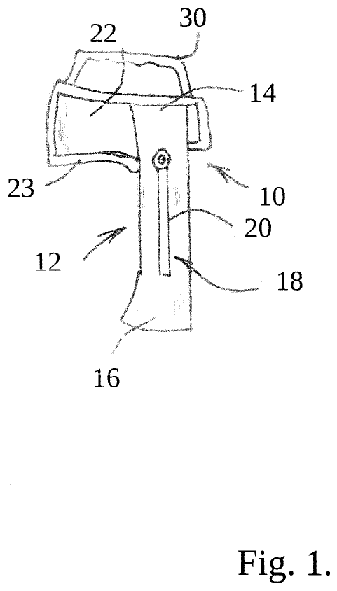

FIG. 1 is a side elevational view of a cutting tool generally designated 10 according to the present invention including a safety sheath 23. As shown in FIG. 1, the cutting tool 10 permits a user (not shown) to selectively chop and saw fibrous material such as firewood for a campfire. The cutting tool 10 includes an elongate body generally designated 12 having a first end 14 and a second end 16 disposed spaced from the first end 14. The elongate body 12 defines a handle generally designated 18 which is held by the user to hold the cutting tool 10 during use thereof. The elongate body 12 also defines a slot 20 which extends between the first end 14 and the second end 16 of the elongate body 12. A hatchet head 22 is rigidly secured to the first end 14 of the elongate body 12 for selectively permitting chopping of the fibrous material during use of the cutting tool 10 after the removal of the protective safety sheath 23.

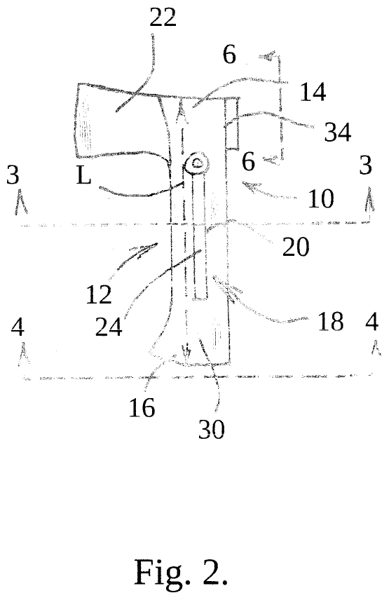

FIG. 2 is a similar view to that shown in FIG. 1 but shows the safety sheath 23 having been removed for use of the cutting tool 10 when being used as a hatchet. As shown in FIG. 2, a saw 24 is stowed within the elongate body 12.

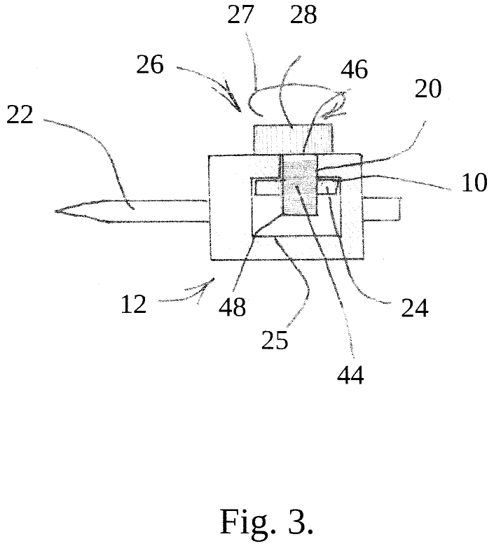

FIG. 3 is an enlarged sectional view taken on the line 3-3 of FIG. 2. FIG. 2. shows the saw 24 in the stowed disposition thereof. As shown in FIG. 3, the saw 24 slidably cooperates with the slot 20 and a channel 25 defined by the elongate body 12 such that in the stowed disposition of the saw 24, as shown in FIGS. 1 to 3, the saw 24 is disposed adjacent to the slot 20 and within the channel 25.

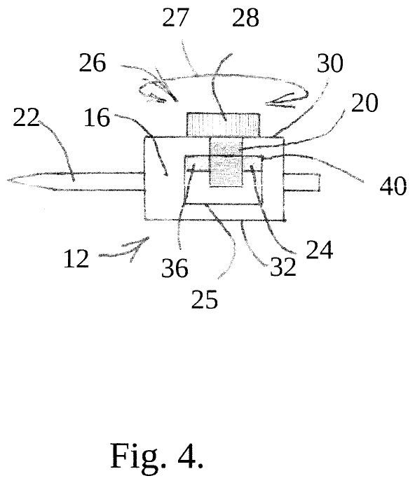

FIG. 4 is an enlarged view taken on the line 4-4 of FIG. 2. FIG. 4 shows and the saw 24 in the stowed disposition thereof. As shown in FIGS. 1 to 2, the slot 20 does not extend to the second end 16 of the elongate body 12. However, as shown in FIGS. 3 and 4, the channel 25 which communicates with and runs parallel to the slot 20 does extend to the second end 16 of the elongate body 12 for permitting the slidable movement of the saw 24 between the stowed and operative dispositions of the saw 24.

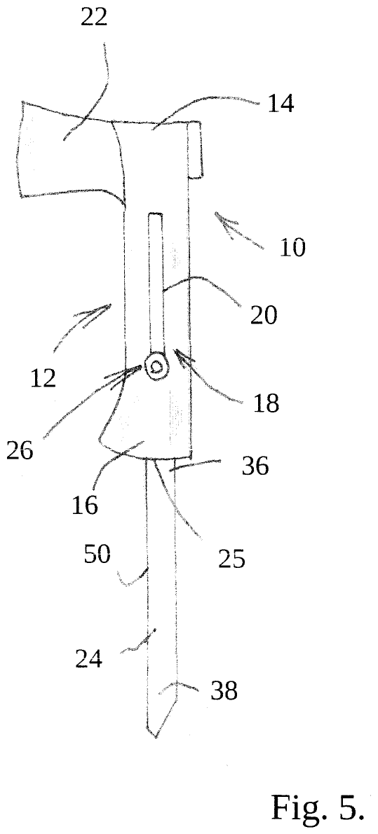

FIG. 5 is a similar view to that shown in FIG. 2 but shows the saw 24 in the operable disposition thereof. As shown in FIG. 5, the saw 24 is fully extended. More specifically, in an operative disposition of the saw 24 as shown in FIG. 5, the saw 24 has been slidably moved longitudinally along the channel 25 away from the hatchet head 22 for selectively permitting the user to saw firewood and the like. As shown in FIG. 5, the saw 24 is locked in the operable disposition by a simple threaded tensioning fastener generally designated 26. As shown in FIGS. 3 and 4, the fastener 26, includes a thumbscrew 28, so that when the thumbscrew 28 is rotated as indicated by the arrow 27 shown in FIG. 4, the thumbscrew 28 is moved towards the saw 24 for wedging and locking the saw 24 against the slot 20. The arrangement according to the present invention permits locking of the saw 24 in various extended locations a feature which is not possible with the prior art pivoting saw arrangements.

Additionally, as shown in FIG. 1, the safety sheath 23 includes a further handle

30.

As shown in FIG. 1, the further handle 30 enables the user to securely hold the cutting tool 10 with both hands during a chopping operation. More specifically, the user holds the handle 18 with one hand and the further handle 30 with the other hand.

In a more specific embodiment of the present invention, the fibrous material

is wood.

Moreover, as shown in FIG. 2, the elongate body 12 includes a longitudinal length L which extends from the first end 14 to the second end 16 of the elongate body 12.

As shown in FIG. 4, the elongate body 12 has a first face 30 and a second face 32 spaced relative to the first face 30.

Additionally, the elongate body 12 is fabricated from wood.

In another embodiment of the present invention, the elongate body is fabricated from metal.

In a further embodiment of the present invention, the elongate body 12 is fabricated from a plastics material.

Additionally, the plastics material is molded.

Furthermore, in each of the embodiments of the present invention, the slot 20 extends longitudinally along a portion of the length L of the elongate body 12 such that the slot 20 extends between the hatchet head 22 and the second end 16 of the elongate body 12.

Also, the slot 20 extends from the first face 30 to the second face 32 of the elongate body 12.

The channel 25 extends from the slot 20 to the second end 16 of the elongate body 12 for the longitudinal reception therethrough of the saw 24.

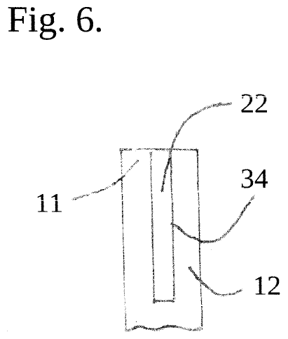

FIG. 6 is a view taken on the line 6-6 of FIG. 2. As shown in FIG. 6, the elongate body 12 defines a transverse opening 34 which is disposed adjacent to the first end 14 of the elongate body 12 for the rigid reception therein of the hatchet head 22 such that the hatchet head 22 is securely fastened to and extends transversely through the transverse opening 34.

Also, as shown in FIG. 5, the saw 24 includes a proximal end 36 and a distal end 38, the distal end 38 being spaced relative to the proximal end 36.

As shown in FIG. 4, the saw 24 defines an internally threaded hole 40 disposed adjacent to the proximal end 36 of the saw 24.

Furthermore, the tensioning fastener generally designated 26 threadably cooperates with the internally threaded hole 40, the tensioning fastener 26 cooperating with the slot 20 such that when the tensioning fastener 26 is rotated relative to the threaded hole 40, as indicated by the arrow 27, the tensioning fastener 26 is selectively urged into a locked disposition relative to the slot 20 at any desired location from the stowed disposition as shown in FIG. 1, to the operative disposition of the saw 24 as shown in FIG. 5.

Additionally, as shown in FIG. 3, the tensioning fastener 26 includes a threaded stem 44 which threadably cooperates with the internally threaded hole 40, the stem 44 having a first extremity 46 and a second extremity 48. The thumbscrew 28 is rigidly secured to the first extremity 46 of the stem 44 and the second extremity 48 of the stem 44 threadably cooperates with the internally threaded hole 40 of the saw 24. The arrangement is such that when the thumbscrew 28 is rotated as indicated by the arrow 27, the thumbscrew 28 cooperates with the slot 20 for locking the saw 24 at a selected location anywhere from the stowed disposition of the saw 24 as shown in FIG. 1 to a fully longitudinally extended disposition of the saw 24 as shown in FIG. 5.

In operation of the cutting tool 10 according to the present invention, the hatchet head 22 is used for chopping branches while the saw 24 is locked within the elongate body 12 of the cutting tool 10. The saw 24 is easily extended longitudinally from the elongate body 12 and locked at any desired length of the saw 24 and without having to manually touch the sharp teeth 50 of the saw 24.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

Included in such modifications would be the provision of one or more of the following features:
1/ A fire starter which includes a magnesium rod that is disposed within the sheath or the handle.
2/ A belt arrangement for attaching the tool to a belt or backpack.
3/ A clip for attachment of the tool to a belt or backpack.
4/ A measuring tool attached to the tool.
5/ A solar charged flexible photovoltaic panel included in a carrying bag for the tool.
6/ A fixed blade knife disposed adjacent to the retractable saw.
7/ A hole defined by the tool for attaching a lanyard.
8/ The thumbscrew cooperating with either the first face 30 or the second face 32.
9/ A blade sharpener.
10/ A compass.
11/ A double edged saw having saw teeth on one side and a blade on the opposite side.
12/ Finger grips molded along the further handle.
13/ Saw teeth on both sides.
14/ Various sized hexagonal holes defined along the length L of blade.
15/ The further handle on the sheath also increasing the reach of the saw.
16/ A blade with saw teeth on one side only but which is selectively removed and replaced after flipping the blade through 180 degrees.

The present invention provides a unique cutting tool for selectively chopping and sawing wood and the like and facilitates adjustment of the saw between an infinite number of operable extended dispositions thereof.

What is claimed is:

1. A cutting tool for permitting a user to selectively chop and saw fibrous material, the cutting tool comprising:
an elongate body having a first end and a second end disposed spaced from said first end, said elongate body defining a handle which is held by the user to hold said cutting tool during use thereof, said elongate body defining a slot and a channel cooperating with said slot, said slot and channel extending between said first end and said second end of said elongate body;
a hatchet head rigidly secured to said first end of said elongate body for selectively permitting chopping of said fibrous material during use of said cutting tool; and
a saw slidably cooperating with said channel such that in a stowed disposition of said saw, said saw is disposed within said slot and said channel and in an operative disposition of said saw, said saw is slidably moved relative to said channel away from said hatchet head for selectively permitting the user to saw the fibrous material.

2. A cutting tool as set forth in claim 1 wherein the fibrous material is wood.

3. A cutting tool as set forth in claim 1 wherein
the elongate body includes:
a longitudinal length which extends from said first end to said second end;
a first face and a second face spaced relative to the first face.

4. A cutting tool as set forth in claim 1 wherein
said elongate body is fabricated from wood.

5. A cutting tool as set forth in claim 1 wherein
said elongate body is fabricated from metal.

6. A cutting tool as set forth in claim 1 wherein
said elongate body is fabricated from a plastics material.

7. A cutting tool as set forth in claim 6 wherein
said plastics material is molded.

8. A cutting tool as set forth in claim 3 wherein
said slot extends longitudinally along a portion of said length of said elongate body such that said slot extends between said hatchet head and said second end of said elongate body.

9. A cutting tool as set forth in claim 8 wherein
said slot extends from said first face to said second face of said elongate body.

10. A cutting tool as set forth in claim 1 wherein
said channel extends from said slot to said second end of said elongate body for said longitudinal reception therethrough of said saw.

11. A cutting tool as set forth in claim 1 wherein
said elongate body defines a transverse opening disposed adjacent to said first end of said elongate body for said rigid reception therein of said hatchet head such that said hatchet head is securely fastened to and extends transversely through said transverse opening.

12. A cutting tool as set forth in claim 1 wherein
said saw includes:
a proximal end and a distal end, said distal end being spaced relative to said proximal end.

13. A cutting tool as set forth in claim 12 wherein
said saw defines an internally threaded hole disposed adjacent to said proximal end of said saw;
a tensioning fastener threadably cooperating with said internally threaded hole, said tensioning fastener cooperating with said slot such that when said tensioning fastener is rotated relative to said threaded hole, said tensioning fastener is selectively urged into a locked disposition relative to said slot at any desired location from said stowed disposition to said operative disposition of said saw.

14. A cutting tool as set forth in claim 13 wherein
said tensioning fastener includes:
a threaded stem which threadably cooperates with said internally threaded hole, said stem having a first and a second extremity;
a thumbscrew rigidly secured to said first extremity of said stem, said second end of said stem threadably cooperating with said internally threaded hole of said saw such that when said thumbscrew is rotated, said thumbscrew cooperates with said slot for locking said saw at a selected location anywhere from said stowed disposition of said saw to a fully longitudinally extended disposition of said saw.

15. A cutting tool for permitting a user to selectively chop and saw fibrous material, the cutting tool comprising:
an elongate body having a first end and a second end disposed spaced from said first end, said elongate body defining a handle which is held by the user to hold said cutting tool during use thereof, said elongate body defining a slot and a channel cooperating with said slot, said slot and said channel extending between said first end and said second end of said elongate body;
a hatchet head rigidly secured to said first end of said elongate body for selectively permitting chopping of the fibrous material during use of said cutting tool;
a saw slidably cooperating with said channel such that in a stowed disposition of said saw, said saw is disposed within said slot and said channel and in an operative disposition of said saw, said saw is slidably moved relative to said channel away from said hatchet head for selectively permitting the user to saw the fibrous material;
said saw defining an internally threaded hole; and
a tensioning fastener threadably cooperating with said internally threaded hole, said tensioning fastener cooperating with said slot such that when said tensioning fastener is rotated relative to said threaded hole, said tensioning fastener is selectively urged into a locked disposition relative to said slot at any desired location from said stowed disposition to said operative disposition of said saw.

16. A cutting tool for permitting a user to selectively chop and saw fibrous material, the cutting tool comprising:
an elongate body having a first end and a second end disposed spaced from said first end, said elongate body defining a handle which is held by the user to hold the cutting tool during use thereof, said elongate body defining a slot and a channel cooperating with said slot, said slot and said channel extending between said first end and said second end of said elongate body;
a hatchet head rigidly secured to said first end of said elongate body for selectively permitting chopping of the fibrous material during use of said cutting tool;
a saw slidably cooperating with said channel such that in a stowed disposition of said saw, said saw is disposed within said slot and said channel and in an operative disposition of said saw, said saw is slidably moved relative to said channel away from said hatchet head for selectively permitting the user to saw the fibrous material;
the fibrous material being wood;
said elongate body including:
a longitudinal length which extends from said first end to said second end;
a first face and a second face spaced relative to said first face;
said elongate body being fabricated from a plastics material;
said plastics material being molded;
said slot extending longitudinally along a portion of said length of said elongate body such that said slot extends between said hatchet head and said second end of said elongate body;
said slot extending from said first face to said second face of said elongate body;
said channel extending from said slot to said second end of said elongate body for said longitudinal reception therethrough of said saw;
said elongate body defining a transverse opening disposed adjacent to said first end of said elongate body for said rigid reception therein of said hatchet head such that said hatchet head is securely fastened to and extends transversely through said transverse opening;
said saw including:
a proximal end and a distal end, said distal end being spaced relative to said proximal end;
said saw defining an internally threaded hole disposed adjacent to said proximal end of said saw;
a tensioning fastener threadably cooperating with said internally threaded hole, said tensioning fastener cooperating with said slot such that when said tensioning fastener is rotated relative to said threaded hole, said tensioning fastener is selectively urged into a locked disposition relative to said slot at any desired location from said stowed disposition to said operative disposition of said saw;
said tensioning fastener including:
a threaded stem which threadably cooperates with said internally threaded hole, said stem having a first and a second extremity; and
a thumbscrew rigidly secured to said first extremity of said stem, said second end of said stem threadably cooperating with said internally threaded hole of said saw such that when said thumbscrew is rotated, said thumbscrew cooperates with said slot for locking said saw at a selected location anywhere from said stowed disposition of said saw to a fully longitudinally extended disposition of said saw.
